(19) United States
(12) Patent Application Publication
(10) Pub. No.: US 2013/0298951 A1
(43) Pub. Date: Nov. 14, 2013

(54) Electric Cleaning Apparatus

(71) Applicants: Weiling Lu, Suzhou (CN); Ji Hua, Suzhou (CN)

(72) Inventors: Weiling Lu, Suzhou (CN); Ji Hua, Suzhou (CN)

(73) Assignee: SUZHOU INDYVAC ELECTRIC APPLICANCE CO., LTD., Suzhou (CN)

(21) Appl. No.: 13/529,026

(22) Filed: Jun. 21, 2012

(30) Foreign Application Priority Data
May 14, 2012 (CN) CN201220214028.1

(51) Int. Cl. A47L 13/42; B08B 7/00

(52) U.S. Cl. 134/58 R

(57) ABSTRACT

Certain exemplary embodiments can provide an electric cleaning apparatus comprising a body, a first cleaning part, a second cleaning part, a first driving part, and/or a second driving part. The first driving part and the second driving part can be driven by a motor simultaneously and/or can drive the first cleaning part and/or the second cleaning part respectively to reciprocate relative to the body. The phase deviations of the motions of the first cleaning part and the second cleaning part can be from approximately 0 degrees to approximately 180 degrees (exclusive of 180 degrees). The cleaning effect can be improved via the reciprocation of the body caused by the phase deviations.

### CROSS-REFERENCE TO RELATED APPLICATIONS

This application claims priority to China Patent Application 201220214028.1 filed on 14 May 2012.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a schematic view showing an exemplary electric cleaning apparatus.

FIG. 2 is a sectional view along line II-II of FIG. 1.

FIG. 3 is an exemplary comparison chart showing exemplary excursions of the first cleaning part and the second cleaning part under different exemplary phase deviations.

FIG. 4 is a schematic view showing an exemplary electric cleaning apparatus.

FIG. 5 is a schematic view showing an exemplary electric cleaning apparatus.

Parts and numbers found in the exemplary drawings include:
10 body
124 first fixed guider
134 second fixed guider
20 first cleaning part
204 first moving guider
206 first restoring spring
30 second cleaning part
304 second moving guider
306 second restoring spring
42 first driving part
422 first driving cam
423 first driving rod
424 first driving wheel
43 second driving part
432 second driving cam
433 second driving rod
434 second driving wheel
44 motor
50 handle
60 cleaner cavity
61 cleaner outlet

### DETAILED DESCRIPTION OF THE EMBODIMENTS

Certain exemplary embodiments can provide an electric cleaning apparatus, such as an electric cleaning apparatus that comprises two cleaning parts capable of and/or adapted for reciprocating and/or driving the body.

Certain exemplary embodiments can provide an electric cleaning apparatus that can provide a cleaning solution that can wipe repeatedly similarly to a person and/or improve the cleaning effect by utilizing the phase deviation of motions of its two cleaning part.

Certain exemplary embodiments can provide an electric cleaning apparatus comprising a body, a first cleaning part and a second cleaning part, both of which can be operatively adapted to reciprocate relative to the body along direction X, a first driving part and a second driving part, both of which can be operatively driven by a motor to make the first cleaning part and the second cleaning part move reciprocally. The motions of the first cleaning part driven by the first driving part and the second cleaning part driven by the second driving part can have a phase deviation from approximately 0 degrees to approximately 180 degrees exclusive.

The electric cleaning apparatus can comprise two cleaning parts adapted for and/or capable of reciprocating so as to simulate the cleaning actions of a human. In addition, the phase deviation of motions of these two cleaning parts can lead to an excursion, motion, shaking, and/or displacement of the body and/or a better cleaning effect.

Certain exemplary embodiments can provide an electric cleaning apparatus, in which the phase deviation is between approximately 158 degrees and approximately 179.9 degrees, so that a better cleaning effect can be achieved.

Certain exemplary embodiments can provide an electric cleaning apparatus, in which the first driving part can comprise a first driving wheel operably and/or transmissibly connecting with the motor. The first driving wheel can be operably connected to the first cleaning part via a first driving rod for driving the first cleaning part reciprocally. The second driving part can comprise a second driving wheel transmissibly connecting with the motor. The second driving wheel can be operably connected to the second cleaning part via a second driving rod for driving the second cleaning part reciprocally.

Certain exemplary embodiments can provide an electric cleaning apparatus, in which the first driving part comprises a first driving cam transmissibly connecting with the motor. The first driving cam can be operably positioned against the first cleaning part for driving the first cleaning part reciprocally. The second driving part can comprise a second driving cam transmissibly connecting with the motor. The second driving cam can be operably positioned against the second cleaning part for driving the second cleaning part reciprocally.

Certain exemplary embodiments can provide an electric cleaning apparatus, in which the apparatus comprises a handle connecting with the body.

Certain exemplary embodiments can provide an electric cleaning apparatus, in which a cleanser cavity is operably arranged on the handle and/or a cleanser outlet is operably arranged on the body for releasing the cleanser to the surface to be cleaned.

Certain exemplary embodiments can provide an electric cleaning apparatus, in which the apparatus comprises a cleanser cavity operably arranged on the body and/or a cleanser outlet operably arranged on the body for releasing cleanser to the surface to be cleaned.

Arranging the cleanser cavity on the handle or body can facilitate the spread of the cleanser on surface to be cleaned and/or achieve a better cleaning effect.

The claimed subject matter will be more clearly understood from the following detailed description taken in conjunction with the accompanying drawings. It should be noted that like reference numerals refer to like parts throughout the several views.

In the views, only the related parts are shown schematically and the like parts or their reference numerals are shown only once for briefness.

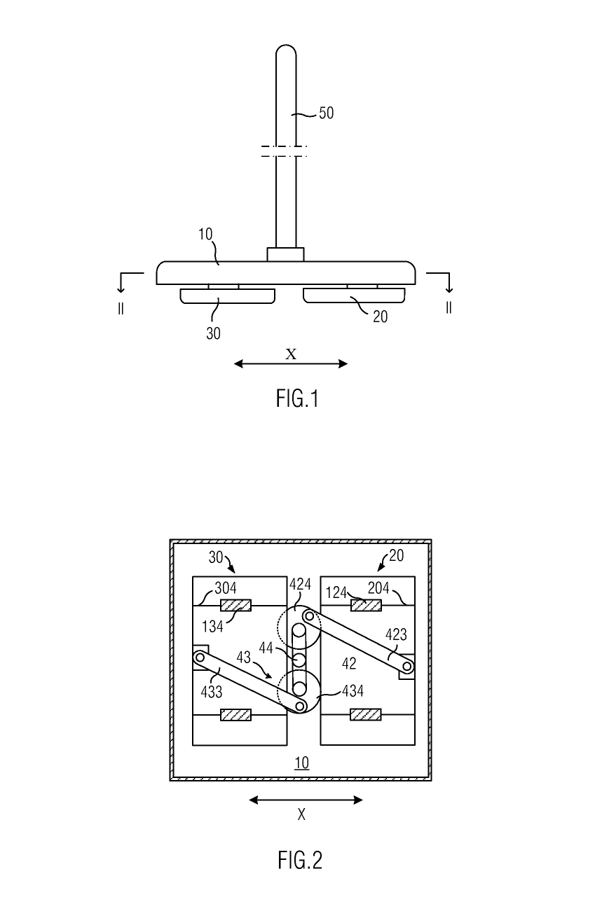

FIG. 1 is a schematic view showing an exemplary electric cleaning apparatus. The electric cleaning apparatus can comprise a body 10, a first cleaning part 20, a second cleaning part 30, a first driving part 42 (shown in FIG. 2), and/or a second driving part 43 (shown in FIG. 2).

As shown in FIG. 2, the first driving part 42 and the second driving part 43 can be driven by a motor 44. The first driving part 42 can operably drive the first cleaning part 20 reciprocally relative to the body 10 along the direction X shown in FIG. 2. The second driving part 43 can operably drive the second cleaning part 30 reciprocally relative to the body 10 along the direction X.

Referring to the exemplary embodiment of an electric cleaning apparatus shown in FIG. 2, the first driving part 42 can comprise a first driving wheel 424 that can be in transmissible and/or operable connection with the motor 44. The first driving wheel 424 can be operably rotatable by the motor 44 and/or can be operably connected with the first cleaning part 20 via a first driving rod 423. Thus the motor 44 can operably drive the first cleaning part 20 reciprocally along direction X. The second driving part 43 can comprise a second driving wheel 434 that can be in transmissible connection with the motor 44. The second driving wheel 434 can be operably rotatable by the motor 44 and/or can be operably connected with the second cleaning part 30 via a second driving rod 433. Thus the motor 44 can operably drive the second cleaning part 30 reciprocally along direction X. The phase deviation between motions of the first cleaning part 20 and of the second cleaning part 30 can between approximately 0 degrees and approximately 180 degrees, exclusive of 180 degrees. The phase deviation is shown as approximately 160 degrees in the exemplary embodiment shown in FIG. 2.

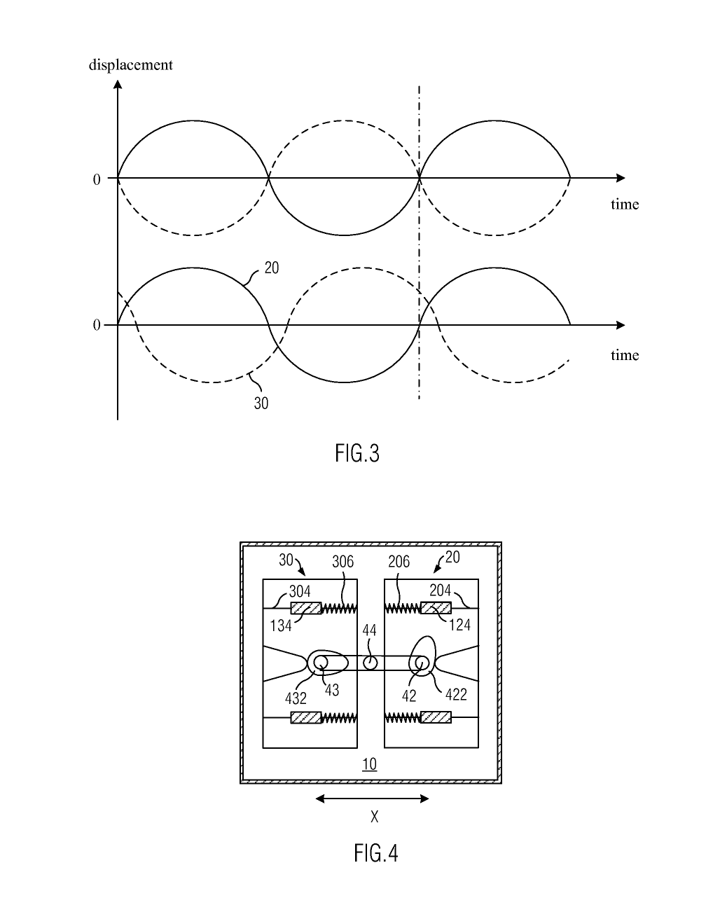

FIG. 3 is an exemplary comparison chart showing the first cleaning part 20 and the second cleaning part 30 under different exemplary phase deviations, wherein the solid lines show the excursion, motion, and/or displacement of the first cleaning part 20 and the dashed lines show the excursion, motion, and/or displacement of the second cleaning part 30.

The exemplary upper portion of FIG. 3 shows that the phase deviation of the motions of first cleaning part 20 and of the second cleaning part 30 at different times is 180 degree. In this exemplary case, the first cleaning part 20 and the second cleaning part 30 reciprocate at a same excursion and/or amplitude, yet in opposite directions, and thus the positions of the first cleaning part 20 and the second cleaning part 30 are symmetrical to the centerline of the body 10 at any time. Therefore, there is a balance between the forces created by the first cleaning part 20 and the forces created by the second cleaning part 30, and no net excursion force occurs, and thus, body 10 will not shift, displace, translate, move, and/or shake due to the reciprocation of the first and second cleaning parts.

The exemplary lower portion of FIG. 3 shows that the phase deviation of the motions of the first cleaning part 20 and the second cleaning part 30 at a different time is approximately 150 degrees. In this exemplary case, the resultant and/or net excursion force resulting from the operable motions of the first cleaning part 20 and the second cleaning part 30 exceeds zero in any given round of reciprocation. The resultant force can circle and/or make body 10 move reciprocally in association with the first and second cleaning parts. The excursion, motion, and/or displacement of body 10 can extend the cleaning area so as to improve the cleaning effect in a given amount of time.

As shown in FIGS. 2 and 3, because the phase deviation between operable motions of the first cleaning part 20 and the second cleaning part 30 can be from approximately 0 degrees to approximately 180 degrees (exclusive), the movements of the first cleaning part 20 and the second cleaning part 30 can be at different paces. The movements of these two cleaning parts can generate an excursion force that can drive the body 10 to excurse, move, and/or displace. Thus, the cleaning area can be extended and/or the cleaning effect can be improved. Based on our research of phase deviations from approximately 0 degrees to approximately 180 degrees, the body 10 has been found to reciprocally excurse in an acceptable manner particularly while the phase deviation is between approximately 158 degrees and approximately 179.9 degrees. Thus the operator can control the electric cleaning apparatus easily and/or the cleaning effect can be better.

Referring to the exemplary embodiment of an electric cleaning apparatus shown in FIG. 2, the position on which the first driving wheel 424 is connected to the first driving rod 423 can be different from the position on which the second driving wheel 434 is connected to the second driving rod 433, so as to achieve a phase deviation between operable motions of the first cleaning part 20 and the second cleaning part 30.

Referring to the exemplary embodiment of an electric cleaning apparatus shown in FIG. 2, the first cleaning part 20 can comprise a pair of first moving guiders 204. A pair of first fixed guiders 124 can be disposed according to the first moving guiders 204 on the body 10. The first moving guider 204 can be positioned through the first fixed guider 124 of the first cleaning part 20 for guiding the first cleaning part 20 to reciprocate relative to the body 10. Referring to the exemplary electric cleaning apparatus in FIG. 2, the second cleaning part 30 can comprises a pair of second moving guiders 304. A pair of second fixed guiders 134 can be disposed according to the second moving guiders 304 on the body 10. The second moving guider 304 can be positioned through the second fixed guider 134 for guiding the second cleaning part 30 to reciprocate relative to the body 10.

Although the first cleaning part 20 and the second cleaning part 30 can reciprocate respectively via the first moving guider 204 and the second moving guider 304 in the exemplary embodiment as shown in FIG. 2, other ways and structures can be used to guide the reciprocation of the first cleaning part 20 and the second cleaning part 30. In addition, the motor 44 can be connected with the first driving wheel 424 and the second driving wheel 434 via a driving belt, a gear, a connecting rod, or other means for transmitting mechanical energy.

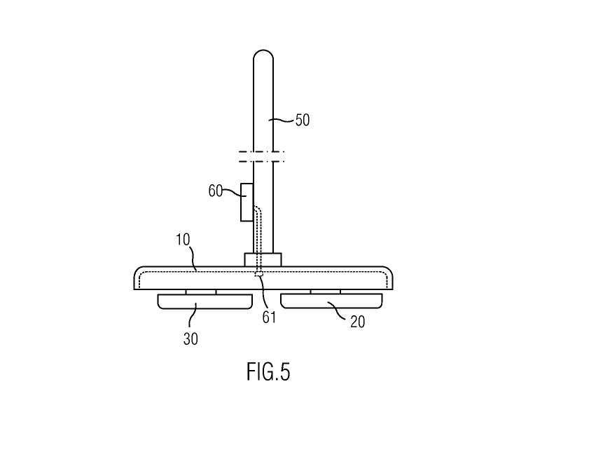

FIG. 4 is a schematic view of an exemplary electric cleaning apparatus. As shown in FIG. 4, the first driving part 42 can comprise a first driving cam 422. The first driving cam 422 can be transmissibly connected with the motor 44 and/or the first driving cam 422 can be rotatably driven by the motor 44. The first driving cam 422 can be positioned against the first cleaning part 20. In this way, the first cleaning part 20 can move reciprocally along direction X when the first driving cam 422 rotates. In the exemplary electric cleaning apparatus shown in FIG. 4, the first cleaning part 20 can comprise a pair of first moving guiders 204 each having a first restoring spring 206 sleeved thereon. The first moving guider 204 can be positioned through the first fixed guider 124 of the body. One end of the first restoring spring 206 can be positioned against the first fixed guider 124 and/or the other end can be positioned against the first cleaning part 20 so that the above reciprocation is realized.

The second driving part 43 can comprise a second driving cam 432. The second driving cam 432 can be transmissibly connected with the motor 44 and/or the second driving cam 432 can be rotatably driven by the motor 44. The second driving cam 432 can be positioned against the second cleaning part 30. Thus, the second cleaning part 30 can move reciprocally along direction X when the second driving cam 432 rotates. In the exemplary electric cleaning apparatus shown in FIG. 4, the second cleaning part 30 can comprise a pair of second moving guider 304 each having a second restoring spring 306 sleeved on. The second moving guider 304 can be positioned through the second fixed guider 134 of the body. One end of the second restoring spring 306 can be positioned against the second fixed guider 134 and/or the other end can be positioned against the second cleaning part 30, so that the above reciprocation is realized. As shown in FIG. 4, because the first driving cam 422 and the second driving cam 432 can have different moving statuses when they are working, the phase deviation between motions of the first cleaning part and the second cleaning part can be from approximately 0 degrees to approximately 180 degrees, exclusive of 180 degrees.

Although the first cleaning part 20 and the second cleaning part 30 can reciprocate respectively via the first moving guider 204 and the first restoring spring 206 in the exemplary embodiment as shown in FIG. 4, other ways and structures can be used to guide the reciprocation of the first cleaning part 20 and/or the second cleaning part 30. In addition, the motor 44 can be connected with the first driving cam 422 and the second driving cam 432 through a driving belt, a gear, a connecting rod, and/or other means for transmitting mechanical energy.

FIG. 5 is a schematic view showing an exemplary electric cleaning apparatus. As shown in FIG. 5, the electric cleaning apparatus can comprise a handle 50 connected with the body 10. The electric cleaning apparatus can comprise a cleanser cavity 60 on the handle 50. The cleanser cavity 60 can be a separate member and/or a part of the handle 50. A cleanser outlet 61 can be arranged on the body 10 for releasing cleanser stored in the cleaner cavity 60 to the surface to be cleaned, which can improve the cleaning effect while the first cleaning part 20 and the second cleaning part 30 are reciprocating and/or cleaning the surface. Alternatively, the cleanser cavity 60 can be positioned on the body 10 and accordingly a cleanser outlet 61 can be provided on the body 10 for releasing the cleanser therein to surface to be cleaned.

Because the phase deviation can be from approximately 0 degrees to approximately 180 degrees (exclusive of 180 degrees), the first cleaning part 20 and the second cleaning part 30 need not reciprocate at the same distance and/or displace the same amount in opposite directions at all time. Thus, the body of the electric cleaning apparatus can move, shake, excurse, and/or reciprocate when cleaning, so that the cleaning area is extended and/or the cleaning effect is improved.

### Note

The word “exemplary” is used exclusively herein to mean “serving as an example, instance, and/or illustration.” Any embodiment described herein as “exemplary” is not necessarily to be construed as preferred or advantageous over other embodiments.

Various substantially and specifically practical and useful exemplary embodiments of the claimed subject matter are described herein, textually and/or graphically. Any of numerous possible variations (e.g., modifications, augmentations, embellishments, refinements, and/or enhancements, etc.), details (e.g., species, aspects, nuances, and/or elaborations, etc.), and/or equivalents (e.g., substitutions, replacements, combinations, and/or alternatives, etc.) of one or more embodiments described herein might become apparent upon reading this document to a person having ordinary skill in the art, relying upon his/her expertise and/or knowledge of the entirety of the art and without exercising undue experimentation. The inventor(s) expects skilled artisans to implement such variations, details, and/or equivalents as appropriate, and the inventor(s) therefore intends for the claimed subject matter to be practiced other than as specifically described herein. Accordingly, as permitted by law, the claimed subject matter includes and covers all variations, details, and equivalents of that claimed subject matter. Moreover, as permitted by law, every combination of the herein described characteristics, functions, activities, substances, and/or structural elements, and all possible variations, details, and equivalents thereof, is encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language herein should be construed as indicating any non-claimed subject matter as essential to the practice of the claimed subject matter.

Thus, regardless of the content of any portion (e.g., title, field, background, summary, description, abstract, drawing figure, etc.) of this document, unless clearly specified to the contrary, such as via explicit definition, assertion, or argument, or clearly contradicted by context, with respect to any claim, whether of this document and/or any claim of any document claiming priority hereto, and whether originally presented or otherwise:
there is no requirement for the inclusion of any particular described characteristic, function, activity, substance, or structural element, for any particular sequence of activities, for any particular combination of substances, or for any particular interrelationship of elements;
no described characteristic, function, activity, substance, or structural element is “essential”;
any two or more described substances can be mixed, combined, reacted, separated, and/or segregated;
any described characteristics, functions, activities, substances, and/or structural elements can be integrated, segregated, and/or duplicated;
any described activity can be performed manually, semi-automatically, and/or automatically;
any described activity can be repeated, any activity can be performed by multiple entities, and/or any activity can be performed in multiple jurisdictions; and
any described characteristic, function, activity, substance, and/or structural element can be specifically excluded, the sequence of activities can vary, and/or the interrelationship of structural elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted.

When any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any phrase (i.e., one or more words) appearing in a claim is followed by a drawing element number, that drawing element number is exemplary and non-limiting on claim scope.

No claim of this document is intended to invoke paragraph six of 35 USC 112 unless the precise phrase “means for” is followed by a gerund.

Any information in any material (e.g., a U.S. patent, U.S. patent application, book, article, etc.) that has been incorporated by reference herein, is incorporated by reference herein in its entirety to its fullest enabling extent permitted by law yet only to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Within this document, and during prosecution of any patent application related hereto, any reference to any claimed subject matter is intended to reference the precise language of the then-pending claimed subject matter at that particular point in time only.

Accordingly, every portion (e.g., title, field, background, summary, description, abstract, drawing figure, etc.) of this document, other than the claims themselves and any provided definitions of the phrases used therein, is to be regarded as illustrative in nature, and not as restrictive. The scope of subject matter protected by any claim of any patent that issues based on this document is defined and limited only by the precise language of that claim (and all legal equivalents thereof) and any provided definition of any phrase used in that claim, as informed by the context of this document.

What is claimed is:

1. An electric cleaning apparatus comprising:
a body;
a first cleaning part operably adapted to reciprocate relative to the body along a predetermined direction;
a second cleaning part operably adapted to reciprocate relative to the body along the predetermined direction;
a first driving part and a second driving part, the first driving part and the second driving part operably adapted to be driven by a motor to reciprocally move the first cleaning part and the second cleaning part;
wherein a motion of the first cleaning part has a phase deviation with respect to a motion of the second cleaning part, the phase deviation from approximately 0 degrees to approximately 180 degrees, exclusive of 180 degrees.

2. The apparatus according to claim 1, wherein:
the phase deviation is between approximately 158 degrees and approximately 179.9 degrees.

3. The apparatus according to claim 1, wherein:
the first driving part comprises a first driving wheel operably adapted to transmissibly connect with the motor, the first driving wheel operably adapted to connect to the first cleaning part via a first driving rod; and
the second driving part comprises a second driving wheel operably adapted to transmissibly connect with the motor, the second driving wheel operably adapted to connect to the second cleaning part via a second driving rod.

4. The apparatus according to claim 1, wherein:
the first driving part comprises a first driving cam operably adapted to transmissibly connect with the motor, the first driving cam operably positioned against the first cleaning part; and
the second driving part comprises a second driving cam operably adapted to transmissibly connect with the motor, the second driving cam operably positioned against the second cleaning part.

5. The apparatus according to claim 1, wherein:
the apparatus comprises a handle operably connecting with the body.

6. The apparatus according to claim 5, wherein:
the apparatus comprises a cleanser cavity arranged on the handle, and a cleanser outlet is arranged on the body for operably releasing a cleanser to a surface to be cleaned.

7. The apparatus according to claim 1, wherein:
the apparatus comprises a cleanser cavity arranged on the body, and a cleanser outlet is arranged on the body for operably releasing a cleanser to a surface to be cleaned.
